(19) United States
(12) Patent Application Publication
(10) Pub. No.: US 2019/0052102 A1
(43) Pub. Date: Feb. 14, 2019

(54) Overvoltage Protection in Wireless Power Transfer

(71) Applicant: Apple Inc., Cupertino, CA (US)

(72) Inventors: Weiyun Chen, Cupertino, CA (US); Stephen C. Terry, Cupertino, CA (US); Yongxuan Hu, Cupertino, CA (US)

(21) Appl. No.: 15/840,172

(22) Filed: Dec. 13, 2017

Related U.S. Application Data
(60) Provisional application No. 62/544,166, filed on Aug. 11, 2017.

(51) Int. Cl. H02J 7/00; H02J 50/12; H02J 7/02

(52) U.S. Cl. CPC H02J 7/0029; H02J 7/025; H02J 50/12

(57) ABSTRACT

Disclosed herein are a method, system and non-transitory program storage device for protecting a power converter from overvoltage conditions in wireless power transfer. In some embodiments, the power converter may use a controllable current sink to discharge an output voltage of the power converter's receiver so as to maintain the output voltage below an overvoltage threshold. In some embodiments, a peak current of the current sink may be controlled as a function of the output voltage. In some embodiments, the current sink may be enabled and/or disabled according to a duty cycle and a frequency, wherein the frequency may be maintained beyond an audible range. In some embodiments, the power converter may bypass the receiver responsive to the output voltage exceeding a limit, thus effectively disabling the power transfer from a transmitter to the receiver.

### TECHNICAL FIELD

This disclosure relates generally to the field of power conversion and, in particular, to overvoltage protection in wireless power transfer.

### BACKGROUND

A power converter may experience overvoltage, especially at output terminal(s), during load transients. For example, when a load of the power converter is released (i.e., the load being disconnected and/or decreased), it may cause a voltage spike at the output terminal(s) of the power converter. This may occur because the power converter cannot respond sufficiently quickly to the load reduction. As a result, an excessive amount of energy may charge the output terminal(s) to overvoltage, rather than being consumed by the reduced load.

In wireless power transfer, an electronic device, for example, a mobile phone, tablet, or wearable electronic device, may be charged wirelessly by a charging station. The charging station may include a power converter, wherein power may be transferred wirelessly from a “transmitting” end (i.e., a transmitter) to a “receiving” end (i.e., a receiver) and delivered to the electronic device. The amount of power required for the charging may depend on a variety of factors, including the degree of wireless coupling between the transmitter and receiver. Even small movements of the receiver with respect to the transmitter may result in significant charging load changes, which may substantially reduce the output power required. Because the electronic device may be incidentally moved during charging, the power converter needs to be able to respond sufficiently quickly to rapid load changes, otherwise overvoltages may result. The overvoltage may impose safety and/or reliability risks to the power converter. To address the overvoltage, one may also have to consider restraints that stem from the usage of charging stations in practice, such as audible noises and thermal losses. Thus, what is needed is overvoltage protection for wireless power transfer that may work efficiently and beyond the audible range.

### SUMMARY

Disclosed herein are a method, system and non-transitory program storage device for protecting a power converter from overvoltage conditions in wireless power transfer. In some embodiments, the power converter may comprise a controllable voltage-limiting load (e.g., a controllable current sink) that may discharge an output voltage of the power converter's receiver and thus clamp the output voltage below an overvoltage threshold. In some embodiments, a value of the voltage-limiting load, for example, a peak current of the current sink, may be controlled as a function of the output voltage value and/or a thermal management requirement. In some embodiments, the voltage-limiting load may be enabled and/or disabled with a duty cycle. In some embodiments, the duty cycle may be regulated as a function of the output voltage and/or thermal management requirement. In some embodiments, the duty cycle may be regulated at a frequency that is beyond the audible range for humans, for example, over 20 kHz. In some embodiments, the duty cycle and/or frequency may be controlled using a hardware-based hysteretic controller and a pulse-width modulation (PWM) timer. In some embodiments, the duty cycle and/or frequency may be controlled using a microcontroller. In some embodiments, the power converter may bypass the receiver using switches, thus effectively disabling the power transfer from the transmitter to the receiver.

### BRIEF DESCRIPTION OF THE DRAWINGS

Various embodiments of the disclosed concepts are illustrated by way of example and not by way of limitation in the accompanying drawings in which like references indicate similar elements. It should be noted that references to “an”, “one” or “another” embodiment in this disclosure are not necessarily to the same or different embodiment, and they mean at least one. In order to be concise, a given figure may be used to illustrate the features of more than one embodiment, or more than one species of the disclosure, and not all elements in the figure may be required for a given embodiment or species. Additionally, features from multiple figures may be combined into some embodiments.

FIG. 1 shows an exemplary receiver of a power converter with a controllable current sink.

FIG. 2 shows an exemplary hardware-based overvoltage protection system.

FIG. 3 shows a block diagram to illustrate an exemplary microcontroller-based overvoltage protection system.

FIG. 4 shows a flowchart of an exemplary overvoltage protection.

### DETAILED DESCRIPTION

In the following description, for purposes of explanation, numerous specific details are set forth to provide a thorough understanding of the disclosed concepts. As part of this description, some of this disclosure's drawings represent structures and devices in block diagram form to avoid obscuring the disclosure. In the interest of clarity, not all features of an actual implementation are described in this disclosure. Moreover, the language used in this disclosure has been principally selected for readability and instructional purposes, and may not have been selected to delineate or circumscribe the disclosed subject matter, resorting to the claims being necessary to determine such disclosed subject matter.

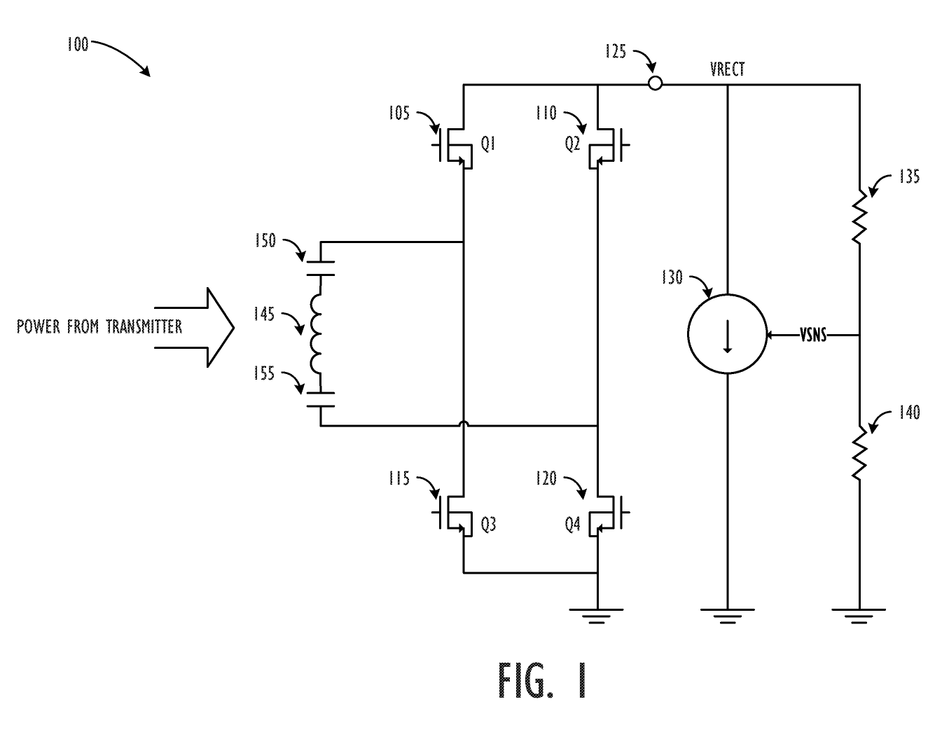

FIG. 1 shows exemplary receiver 100 of a power converter with a controllable current sink. As shown in FIG. 1, receiver 100 may comprise switches Q1 105, Q2 110, Q3 115 and Q4 120 that may receive power from a transmitter (not shown) and generate an output voltage V_{RECT} at output node 125. For example, receiver 100 may include coil 145 and, optionally, one or more capacitors 150/155. Coil 145 and capacitors 150/155 may implement a secondary coil that is wireless coupled to a primary coil (not shown) to receive power wirelessly from the transmitter. Once power is received by receiver 100, e.g., through coil 145 and capacitors 150/155, switches Q1 105, Q2 110, Q3 115 and Q4 120 may be controlled to perform voltage rectification and create a direct current (DC) output voltage V_{RECT} at output node 125.

As mentioned above, load transients in wireless power transfer may cause overvoltage to the output voltage V_{RECT} of receiver 100. Thus, receiver 100 may include controllable current sink 130, as a controllable voltage-limiting load, to discharge the output voltage V_{RECT} during voltage spikes and accordingly clamp the output voltage V_{RECT} below an overvoltage threshold. In particular, as shown in FIG. 1, current sink 130 may be controlled based on signal V_{SNS} that is representative of the output voltage V_{RECT}. Note that the signal V_{SNS} may be derived from the output voltage V_{RECT} using a voltage divider of resistors 135 and 140. Alternatively, the signal V_{SNS} may represent the output voltage V_{RECT} using other types of voltage sensing circuits, isolated or non-isolated.

Additionally, the value of controllable current sink 130, e.g., a peak current I_{LOAD} of controllable current sink 130, may be controlled based on the signal V_{SNS}. For example, current sink 130 may employ an active current load comprising one or more semiconductor devices such as transistors. These transistors may operate in a saturation region to create different peak current I_{LOAD} for current sink 130.

Further, current sink 130 may be enabled and/or disabled with a duty cycle. The duty cycle may be regulated responsive to the output voltage V_{RECT} (represented by the signal V_{SNS}) and/or thermal management requirement of the receiver (or the power converter). In particular, when current sink 130 is enabled, current sink 130 may discharge the output voltage V_{RECT} and thus prevent overvoltage. Conversely, when the output voltage V_{RECT} falls within a safe region, current sink 130 may be disabled, thus preventing a current from continuously flowing through current sink 130 and creating further losses. Additionally, the duty cycle of current sink 130 may be regulated at a frequency that is beyond the audible range, for example, over 20 kHz.

Finally, the power converter may bypass receiver 100, for example, by closing switches Q3 115 and Q4 120 in FIG. 1, which may effectively disable the power transfer from the transmitter to the receiver. Note that to facilitate understanding of the disclosure, only a simplified receiver of a power converter is depicted in FIG. 1. In practice, the power converter and its receiver for wireless power transfer may comprise other components and circuits for purposes of wireless power transfer, voltage/power regulation, communications, control, diagnosis, and so on.

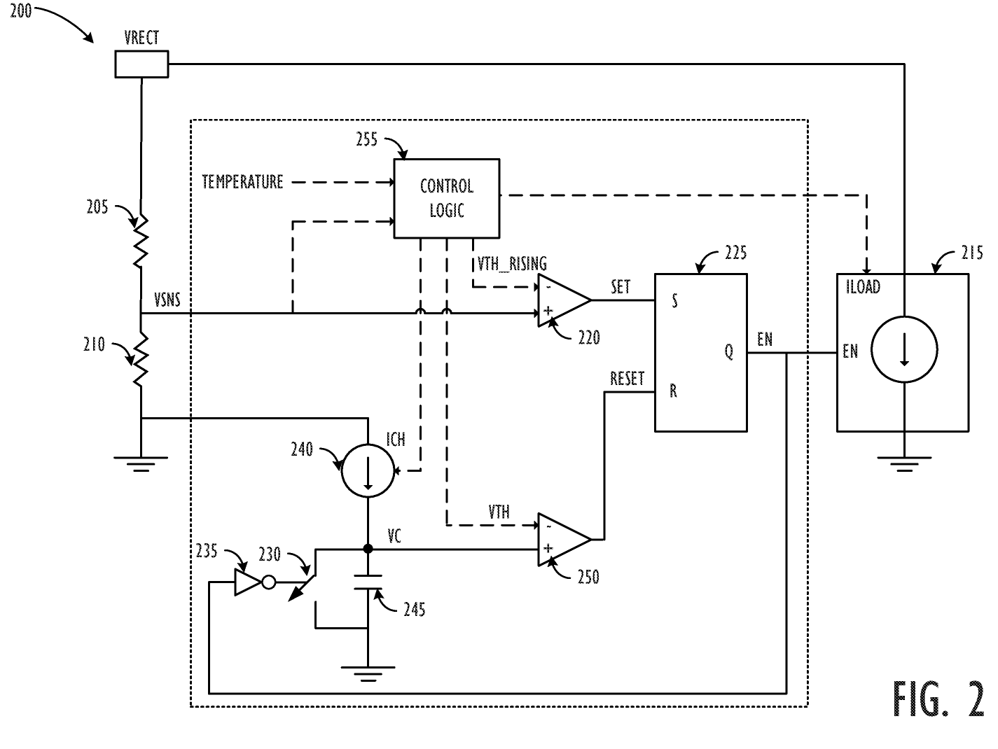

FIG. 2 shows exemplary hardware-based overvoltage protection system 200. As shown in FIG. 2, an output voltage V_{RECT} of a receiver may be sensed, for example, through a voltage divider of resistors 205 and 210, to generate a signal V_{SNS}. The signal V_{SNS} may be sent to comparator 220, which may generate a SET signal based on a differential between V_{SNS} and a threshold V_{TH}_{_}_{RISING}. In particular, when the output voltage V_{RECT} is large enough such that the signal V_{SNS} reaches the threshold V_{TH}_{_}_{RISING}, comparator 220 may assert the SET signal to logic high. Conversely, when the output voltage V_{RECT} falls within a safe region such that the V_{SNS} becomes less than the threshold V_{TH}_{_}_{RISING}, comparator 220 may assert the SET signal to logic low. When the SET signal is high, S-R latch 225 may generate a logic high EN signal to enable current sink 215. When current sink 215 is enabled, it may discharge and reduce the output voltage V_{RECT}.

Further, when the EN signal becomes high, it may start a PWM timer. In particular, the logic high EN signal may turn off switch 230 through inverter (i.e., NOT gate) 235. Thus, current source 240 may start to charge capacitor 245 that may produce a capacitor voltage across capacitor 245 according to equation (1):

$${V}_{c} = \int \frac{{I}_{CH}}{C} dt = \frac{{I}_{CH}}{c} t , \qquad ( 1 )$$

where V_{C} is the voltage of capacitor 245, C is the capacitance of capacitor 245, I_{CH} is the current of current source 240, and t represents time. In other words, for given C and I_{CH}, the capacitor voltage V_{C} may increase proportionally with time t, which essentially represents the function of a PWM timer. Assuming after a period of T_{ON}, the capacitor voltage V_{C} may reach a threshold V_{TH}, comparator 250 may assert a log high RESET signal to reset S-R latch 225, which may cause the EN signal to become low. When the EN signal becomes low, it may disable current sink 215 and stop discharging the output voltage V_{RECT}. Consequently, the output voltage V_{RECT} may start to increase again. Assuming after a period of T_{OFF}, the output voltage V_{RECT} (and feedback signal V_{SNS}) becomes large enough such that comparator 220 may re-assert the SET signal to high, overvoltage protection system 200 may move into a next cycle to repeat the above-described operations. Thus, the two periods T_{ON} and T_{OFF} may determine the duty cycle and frequency to enable and/or disable current sink 215 according to equations (2) and (3):

$$\begin{matrix}D = \frac{{T}_{ON}}{{T}_{ON} + {T}_{OFF}} , & ( 2 ) \\ f = \frac{1}{{T}_{ON} + {T}_{OFF}} , & ( 3 )\end{matrix}$$

where D represents the duty cycle and f is the frequency. The overvoltage protection system 200 may further use control logic 255 to regulate the duty cycle D and maintain the frequency f beyond the audible range. In particular, control logic 255 may control the currents I_{CH} and I_{LOAD} and the thresholds V_{TH}_{_}_{RISING} and V_{TH}, based on the output voltage V_{RECT} and temperature of the receiver (or temperature of the power converter). For example, control logic 255 may set the current I_{CH} to be proportional to the peak current I_{LOAD} of current sink 215 (e.g., I_{CH}=k_{LOAD}). As the peak current I_{LOAD} increases, the current I_{CH} may increase, and therefore it may take a shorter period of T_{ON} for capacitor 245's voltage V_{C} to reach threshold V_{TH}. As T_{ON} becomes shorter, the duty cycle D may reduce, and frequency f may increase for a given period T_{OFF}.

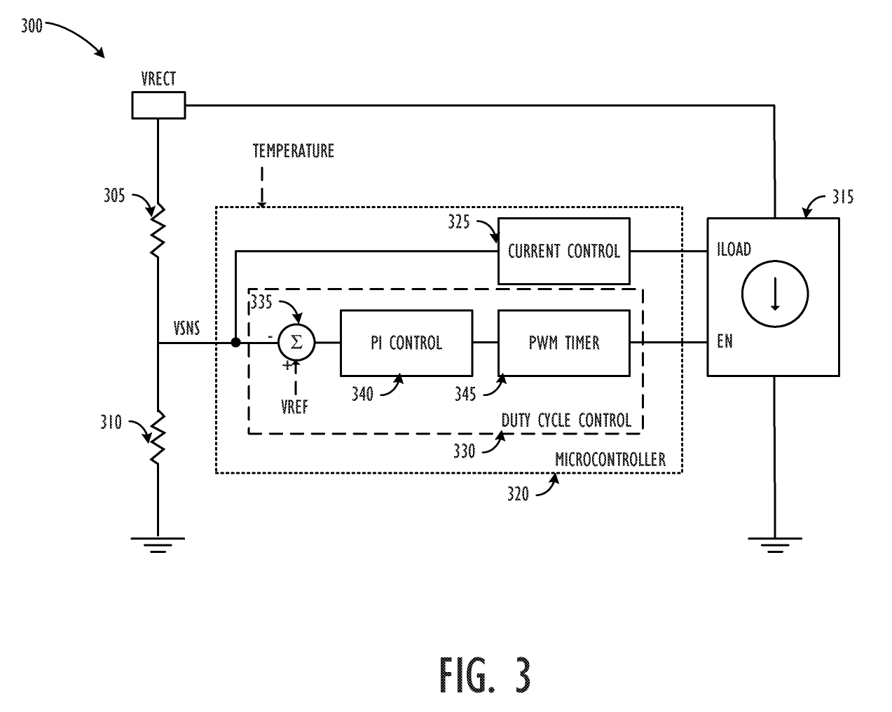

FIG. 3 shows a block diagram illustrating an exemplary microcontroller-based overvoltage protection system 300. As shown in FIG. 3, an output voltage V_{RECT} of a receiver may be sensed through a voltage divider of resistors 305 and 310 to generate a signal V_{SNS}. The signal V_{SNS} may be fed into microcontroller 320, which may accordingly control the peak current I_{LOAD} and duty cycle of current sink 315. In particular, microcontroller 320 may comprise current control 325 and duty cycle control 330. Current control 325 may adjust the peak current I_{LOAD} of current sink 315 based on the output voltage V_{RECT} (through the signal V_{SNS}). Duty cycle control 330 may use comparator 335 to provide a differential between signal V_{SNS} and reference voltage V_{REF}. The differential may then be used by proportional-integral (PI) control 340 to generate a duty cycle command for PWM timer 345. PWM timer 345 may enable and/or disable current sink 315 according to the duty cycle command, with a programmed frequency. The programmed frequency of PWM timer 345 may be a constant frequency beyond the audible range (e.g., higher than 20 kHz), which may be preset and/or adjustable during operation. Microcontroller 320 may also receive a sensed temperature of the receiver (or the power converter) and adjust the peak current I_{LOAD} and/or duty cycle of current sink 315 as needed. Note that FIG. 3 depicts PI control 340 merely as an example. Microcontroller 320 may use various types of control, for example, proportional, proportional-integral, proportional-integral-derivative, fuzzy logic, artificial intelligence, etc., to generate the duty cycle command.

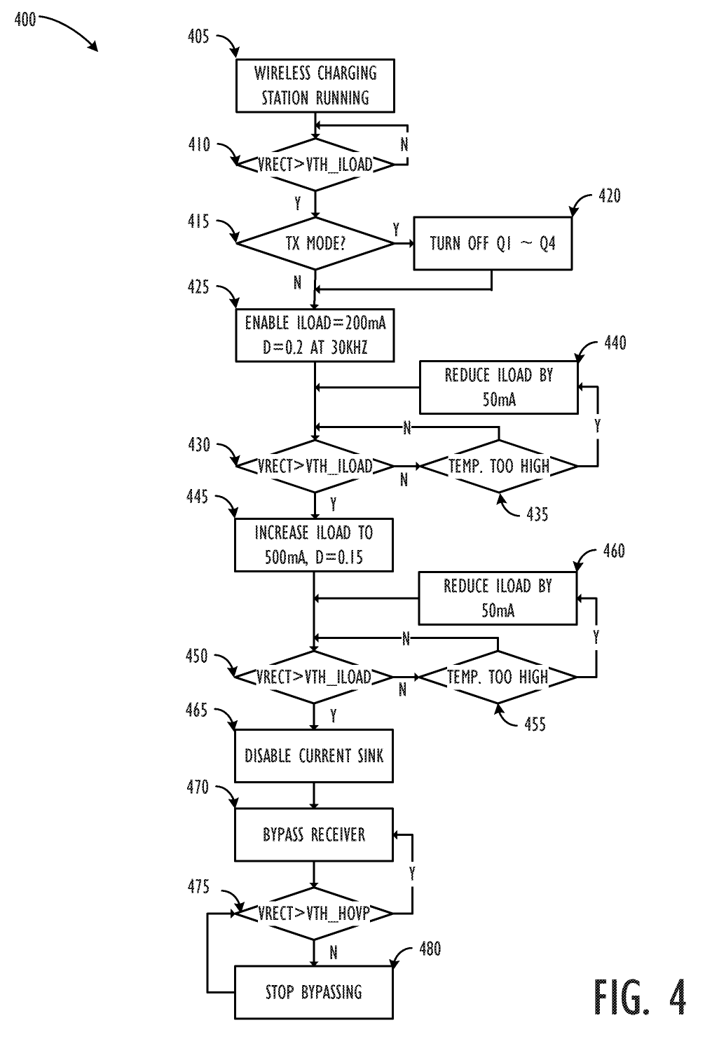

FIG. 4 shows flow chart 400 illustrating an exemplary overvoltage protection method. At step 405, a wireless charging station may start running. At step 410, an output voltage V_{RECT} of a receiver of the wireless charging station may be monitored to detect whether or not it exceeds a threshold V_{TH}_{_}_{ILOAD}. If V_{RECT} is greater than a threshold V_{TH}_{_}_{ILOAD}, the receiver may be further detected whether it is in a transmitting (TX) mode or a receiving (RX) mode at step 415. As the transmitter and receiver of the wireless charging station may be functionally exchangeable during operation, power may be transferred wirelessly bi-directionally. The receiver may involve different operations between the TX and RX modes. For example, if the receiver is in the TX mode, switches Q1 105, Q2 110, Q3 115 and Q4 120 may be turned off at step 420. Otherwise, at step 425, a current sink may be enabled with, for example, a peak current I_{LOAD} of 200 mA, a duty cycle of 0.2 and a frequency of 30 kHz. At step 430, the output voltage V_{RECT} may again be checked to detect if it is still larger than the threshold V_{TH}_{_}_{ILOAD}. If V_{RECT} falls below the threshold V_{TH}_{_}_{ILOAD}, at step 435, a temperature of the receiver (or the wireless charging station) may be examined. If over-temperature is detected, the peak current I_{LOAD} of the current sink may be reduced by, for example, 50 mA, at step 440. Conversely, if V_{RECT} continuously remains larger than the threshold V_{TH}_{_}_{ILOAD}, the peak current I_{LOAD} of the current sink may be increased at step 445, for example, to 500 mA, still at 30 kHz; and the duty cycle may be reduced, for example, to 0.15. At step 450, the output voltage V_{RECT} may be continuously compared with the threshold V_{TH}_{_}_{ILOAD}. Once again, if V_{RECT} falls below the threshold V_{TH}_{_}_{ILOAD}, over-temperature of the receiver (or the wireless charging station) may be checked again at step 455. If over-temperature is detected, at step 460, the peak current I_{LOAD} of the current sink may be reduced by, for example, 50 mA. Note that the initial value and reduction of the peak current I_{LOAD} (e.g, 200 and 50 mA), the duty cycles (e.g., 0.2 and 0.15) and frequency (30 kHz) are used herein merely as examples. Those parameters may be preset and/or adjustable to other numeric values according to the requirements of a particular embodiment. Additionally, some or all of the above-described steps may be repeated and/or iterated. Finally, if the output voltage V_{RECT} remains constantly greater than the threshold V_{TH}_{_}_{ILOAD} (as determined at step 450), the power converter may disable the current sink at step 465 and bypass the receiver at step 470, for example, by closing switches Q3 115 and Q4 120 as shown FIG. 1. Once the receiver is bypassed, the power converter may check if the output voltage V_{RECT} falls below a second threshold V_{TH}_{_}_{HOVP} at step 475 (e.g., V_{TH}_{_}_{HVOP}>V_{TH}_{_}I_{LOAD}). If so, the power converter may revive the receiver at step 480, for example, by turning off switches Q3 115 and Q4 120 in FIG. 1.

The various embodiments described above are provided by way of illustration only and should not be constructed to limit the scope of the disclosure. Various modifications and changes can be made to the principles and embodiments herein without departing from the scope of the disclosure and without departing from the scope of the claims.

1. A method to protect a wireless charging station from overvoltage, comprising:
providing a controllable load to a receiver of a wireless charging station;
adjusting at least one of a duty cycle, an amplitude and a frequency of the controllable load so as to maintain an output voltage of the receiver below a first threshold.

2. The method of claim 1, wherein the frequency of the controllable load is controlled to be beyond an audible range.

3. The method of claim 1, wherein the controllable load comprises a controllable current sink.

4. The method of claim 3, wherein the controllable current sink comprises an active current load including one or more semiconductor devices configured to operate in a saturation region.

5. The method of claim 3, further comprising controlling a peak current of the current sink responsive to the output voltage of the receiver.

6. The method of claim 5, wherein the peak current is controlled responsive to a temperature of the receiver.

7. The method of claim 1, further comprising, responsive to the output voltage exceeding a first threshold, bypassing the receiver so as to maintain the output voltage below a second threshold.

8. The method of claim 1, wherein the at least one of a duty cycle and a frequency are determined responsive to the output voltage of the receiver.

9. The method of claim 1, wherein the at least one of a duty cycle and a frequency are controlled by a hysteretic controller and a pulse-width-modulation (PWM) timer.

10. The method of claim 1, wherein the at least one of a duty cycle and a frequency are controlled by a microcontroller.

11. A system to protect a wireless charging station from overvoltage, comprising:
a controllable load coupled to a receiver of a wireless charging station, the receiver configured to receive power from a transmitter of the wireless charging station and generate an output voltage,
wherein the controllable load is configured to adjust at least one of a duty cycle, an amplitude, and a frequency so as to maintain an output voltage of the receiver below a first threshold.

12. The system of claim 11, wherein the frequency of the controllable load is controlled to be beyond an audible range.

13. The system of claim 11, wherein the controllable load comprises a controllable current sink.

14. The system of claim 13, wherein the current sink comprises an active current load including one or more semiconductor devices configured to operate in a saturation region.

15. The system of claim 13, wherein a peak current of the controllable current is controlled responsive to the output voltage of the receiver.

16. The system of claim 11, wherein the at least one of a duty cycle and a frequency are determined responsive to the output voltage of the receiver.

17. The system of claim 11, wherein the receiver is bypassed responsive to the output voltage exceeding a first threshold so as to maintain the output voltage below a second threshold.

18. The system of claim 11, further comprising a hysteretic controller and a pulse-width-modulation (PWM) timer configured to control the at least one of a duty cycle and a frequency of the controllable load.

19. A wireless charging station, comprising:
a transmitter;
a receiver configured to receive power from the transmitter through wireless coupling and provide an output voltage; and
a controllable load coupled to the receiver and configured to adjust at least one of a duty cycle, an amplitude, and a frequency so as to maintain the output voltage of the receiver below a first threshold.

20. The wireless charging station of claim 19, wherein the frequency of the controllable load is controlled to be beyond an audible range.
